(19) United States
(12) Patent Application Publication
(10) Pub. No.: US 2012/0177868 A1
(43) Pub. Date: Jul. 12, 2012

(54) Pole Cover System

(76) Inventor: Michael Horgash, (US)

(21) Appl. No.: 12/986,329

(22) Filed: Jan. 7, 2011

(51) Int. Cl. B65D 65/22; B23P 11/00; B65D 65/02

(52) U.S. Cl. 428/100; 428/99; 29/428

(57) ABSTRACT

A pole cover which is defined as a flexible panel member which incorporates one or more stiffening members that provide support to the pole cover thereby allowing it to be quickly and easily installed upon a receiving member without personnel lifting equipment or multiple personnel. In lieu of adhesives to install the pole cover, a typical connector such as a zipper is utilized to enclose the pole cover around the receiving member.

### FIELD OF THE INVENTION

The present invention relates to a secure pole cover which typically incorporates advertising or decorative designs. This pole cover is quickly and easily removable by utilizing a specialized tool.

### BACKGROUND OF THE INVENTION

For decades owners of upright vertical poles (such as light poles or other column shaped structures) have recognized the value of placing advertising or decorative designs upon said poles.

Representative pole covers are those taught by U.S. Pat. No. 5,112,898 to Dinan. The Dinan device is a two piece design which utilizes mostly thin flexible planar panels affixed to each other in a manner which captures or sandwiches a pole in between said panels. This device allows displaying an advertising message or decorative design upon a pole or vertical member. This appears to be an acceptable manner to display a message, but it does have drawbacks. For example, in order to not interfere with passing vehicle or pedestrian traffic, these devices are typically placed in a manner which is substantially above the ground surface. This can cause a person passing by the device to not see or observe the intended message or decoration being displayed.

Another drawback of this device is that cumbersome equipment must be employed to mount or install the device, such as a lifting mechanism which can carry personnel upward into the air to the desired mounting location. Of course this same cumbersome equipment must also be employed to demount or remove the device. Because this process is time consuming and expensive, the message carried by this device tends to become stale or faded from being displayed for an extended period of time.

Another perceived deficiency of this design is that when the device is mounted in the device since its design inherently provides a certain amount of drag or resistance against wind.

There are also similar devices to the '898 Dinan device such as the device also taught by Dinan in U.S. Pat. No. 4,890,403. This design also seems to share most of the shortcomings of the '898 device.

In an attempt to bring greater visual awareness to advertising on vertical poles, U.S. Pat. Nos. 6,061,939 and 5,782,027 to Gildea teach a decorative member attached to the bottom or lower portion of a vertical pole. Although these devices are physically easier to reach, thus easier to install and remove in comparison to the Dinan devices, the view of the Gildea devices can be easily obscured if vehicles are parked in close proximity to the pole where the device is mounted. Since the devices taught in the Gildea patents are of a semi-rigid 3-dimensional design, they tend to project outward in relation to the lower portion of the pole or its station. These outwardly projecting portions are unsupported by the pole or its station and can cause the Gildea device to become damaged from contact with vehicles or intentional damage from pedestrians. The devices taught by Gildea are also somewhat expensive to manufacture.

Yet another pole cover design is that taught by U.S. Pat. No. 6,363,644 to Frost. This design is a simple wrap around cover which utilizes pairs of string ties to secure the cover to a vertical member. Although this type of a cover would be somewhat inexpensive to manufacture and easy to install or remove (by theft or otherwise), it would likely not provide a secure fitment to the vertical member as the wind would eventually loosen or destroy the members which fasten the cover to the vertical member. This device would also tend to slide downward upon a vertical member such as a pole with a substantially smooth outer surface. Similar to the devices taught by Dinan, the Frost design would also require special lifting equipment to install or remove the device if it was desirable to mount the device an otherwise unreachable distance up from the ground.

It is also well known within the prior art to utilize flexible adhesive backed wraps to decorate vertical members. These devices are generally difficult to install as they require special lifting equipment (such as that necessary with the Dinan devices). This device is also extremely time consuming to install as air bubbles often tend to form between the adhesive backed surface and the vertical member receiving the cover thereby providing a wrinkled cover if said air bubbles are not completely removed. Removing said air bubbles and wrinkles from the device can be time consuming, especially in high wind conditions. It is also doubtful that this type of cover could be successfully applied to a vertical member in moist atmospheric conditions or where elevated wind conditions are present. This device can also be difficult and time consuming to remove from the vertical member as the securing adhesive tends to leave a residue upon the vertical member after being removed. Of course it is usually desirable to also remove the adhesive residue from the vertical member, which can be time intensive or physically damaging to the vertical member.

Therefore, it would be desirable in the art to construct a pole cover device which: a) draws attention to all vertical portions of a pole, b) is securely mounted to a vertical pole member, c) is easily and quickly installed upon or removed from a member by utilizing a simple inexpensive tool without expensive lift equipment, d) is not detrimentally affected by high wind conditions, e) does not leave behind an adhesive residue after its removal, and f) does not harm the vertical member upon which it is mounted or removed.

Accordingly, the present invention overcomes the aforementioned shortcomings of the known prior art and provides improvements as stated above. The present invention is summarized and described in detail below.

### SUMMARY OF THE INVENTION

The present invention is a vertical pole cover which a) draws attention to substantially all vertical portions of a vertical pole, b) is securely mounted to a vertical pole member, c) is easily and quickly installed upon or removed from a member by utilizing a simple inexpensive tool without expensive lift equipment, d) is not detrimentally affected by high wind conditions, e) does not leave behind an adhesive residue after its removal, and 1) does not harm the vertical member upon which it is mounted or removed.

In the preferred embodiment, the vertical pole cover system is comprised of a flexible panel member (pole cover), connector rods, a zipper, an installation tool, and an optional securing strap. The flexible member is sized in an appropriate manner to provide snug fitment upon the outer surface of a vertical pole member. Where the outer surface of a vertical pole member is tapered, the top of the flexible panel member would have a smaller top circumference in comparison to the bottom circumference portion of the pole. Thus, the tapered flexible panel member would be sized to provide a snug fitment along the entire vertical length of the tapered vertical pole to be covered by the flexible panel member. Being positioned upon a substantial portion of the length of the outer vertical surface of the vertical pole, the flexible panel member would then be positioned in a manner to attract the attention of those persons who 1) are located within a close proximity to the vertical pole member, and 2) those persons who may not be able to see the bottom of the vertical pole, but can see nevertheless see the middle and top portions of the vertical pole.

The pole cover is mounted upon a pole member by the following procedure: 1) first inserting the assembled connecting rods within the provided vertical pockets which extend for substantially the length of each connective end of the flexible member, 2) since the assembled connecting rods are resident within the flexible member, the flexible member tends to hold its expanded upward shape thereby allowing the flexible member to be wrapped around the pole member, 3) both connective ends of the flexible member contain half of a typical zipper which extends substantially along the vertical length of the flexible member, 4) the connective ends are joined by a provided zipper which is typically first joined at the bottom and “zipped” by making an upward movement with the slider by utilizing a simple elongated tool with a hook on one end that engages an aperture within pull tab of the slider, and 5) optionally removing the connecting rods from the flexible member once the pole cover is installed upon a vertical pole member. The assembled and installed connecting rods provide enough rigidity to the flexible member that typically one person is able to install the pole cover without the assistance of an expensive lifting mechanism. The connecting rods are very similar to an outdoor/camping tent which utilizes collapsible pole members.

The flexible member can also optionally include a strap located near its lower portion. After the zipper is fully engaged and the connecting rods are optionally removed, the strap is wrapped around the pole member and secured with a snap, velcro, or other such suitable attachment means. This optional strap tightly secures the lower portion of the flexible member to the pole member thereby prohibiting the flexible member from sliding downward upon the pole member.

Since the flexible member is wrapped tightly around the pole member and held in place by a zipper that extends substantially the entire length of the flexible member, high winds do not have a detrimental affect upon the securement of the flexible member. Also, when in the fully zipped position, the slider is located towards the top of the flexible member which is typically too far from the ground to reach without a special tool or lifting device. This makes unauthorized removal of the pole cover more difficult.

To uninstall the pole cover the following procedure is undertaken: 1) the optional strap at the bottom of the flexible member is disengaged from the pole member, 2) the elongated hooked tool is engaged within the pull tab, 3) the zipper is unzipped by making a downward motion of the slider, and 4) the zipper is separated and the flexible member can be easily removed from the vertical pole member. Since there is no adhesive involved in the installation of the flexible member, there is no residue left behind once the flexible member is removed from the vertical pole member.

In summary, my invention provides a combination of the following advantages relative to vertical pole advertising or displays as known within the prior art:

a) my invention can cover substantially the entire vertical length of a vertical pole member. This draws attention to the design or advertising located upon the flexible member since it is not installed only at the top or bottom of a pole member;

b) is secured to a pole member in a manner that prohibits the unauthorized removal of the pole cover;

c) is easy to install without the assistance of additional personnel or personnel lifting equipment;

d) is installed in a manner which is not affected by constant or high winds; and

e) is quickly installed without the use of adhesive, so the removal of the pole cover is quick and easy with no residue left behind on the pole member. To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The above mentioned and other features, advantages and objects of this invention, and the manner of attaining them, will become apparent and the invention itself will be better understood by reference to the following description of embodiments of the invention taken in conjunction with the accompanying drawings, wherein:

FIG. 1 is, a perspective view of a pole cover as installed upon a pole.

FIG. 2 is a view of the back side of a pole cover wherein all of the pieces necessary to install the pole cover are visible.

FIG. 3 is a close up view of the lower portion of the pole cover which provides greater detail of the stiffening member pockets.

FIG. 4 is a view of a stiffening member is a disassembled or collapsed state.

FIG. 5 is a view of a pole cover in its initial installation position.

FIG. 6 is a perspective view of a pole cover partially installed upon a pole by utilizing the elongated hooked tool.

FIG. 7 is a perspective view of the elongated hooked tool.

Like reference numerals indicate the same or similar parts throughout the several figures. A discussion of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF AN EMBODIMENT OF THE INVENTION

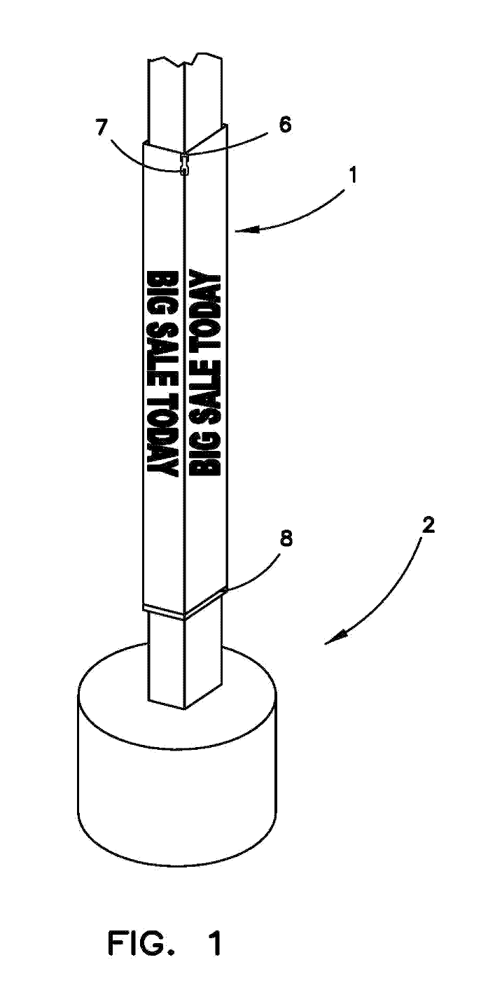

Referring to FIG. 1, a typical pole 2 is shown which could incorporate lighting, traffic control devices, signage, or provide some other functionality. The pole 2 shows the pole cover 1 in the fully installed position wherein the zipper slider 5 and the zipper pull tab 7 are visible and located towards the upper portion of the pole cover 2. FIG. 1 also shows a tension strap 8 fastened and positioned towards the lower portion of the pole cover 1.

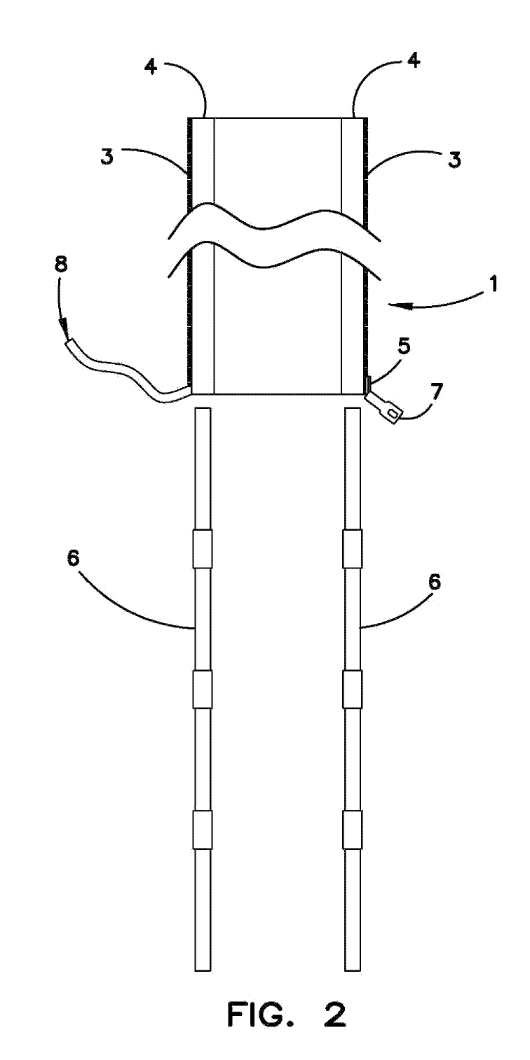

To prepare the pole cover 1 for installation, the pole cover 1 is placed on its front side as shown in FIG. 2. While lying on its front side, the back portion of the pole cover 1 is visible. From this view you can see the zipper halves 3, the zipper slider 5, the zipper pull tab 7, stiffening members 6, the stiffening member pockets (pockets) 4, and the tension strap 8.

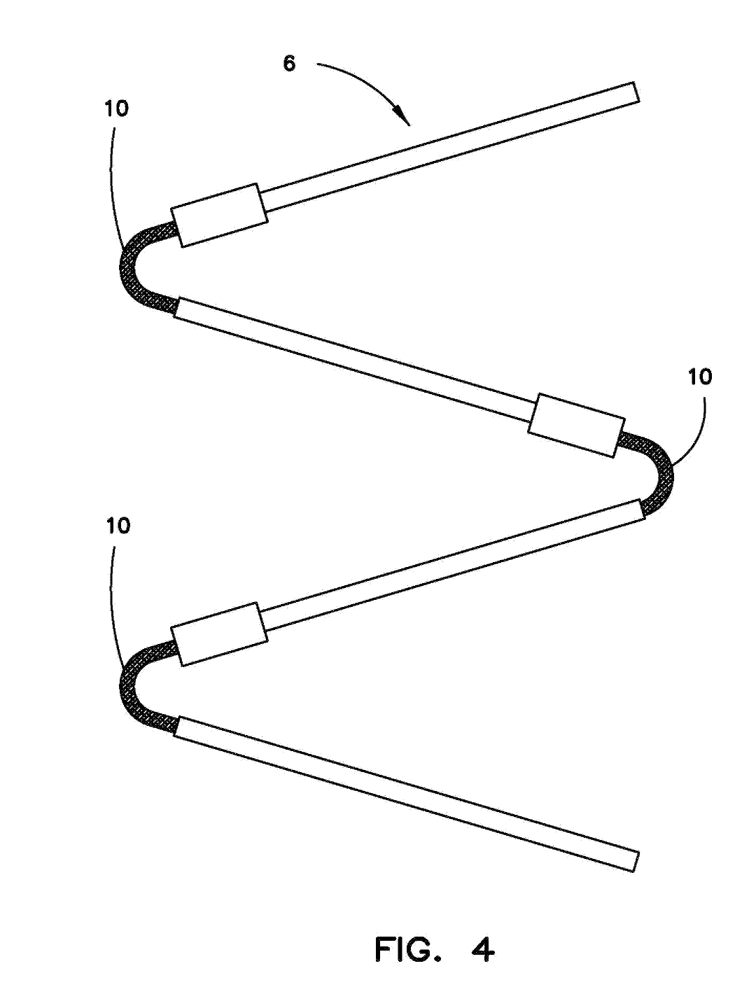

Briefly referring to FIG. 4, a stiffening member 6 is shown as unassembled and not inserted within the pole cover 1. The stiffening pole 6 segments are semi-detachable from each other in that they are joined by an elastic bungee type cord 10. Each stiffening pole 6 is very similar in construction to a collapsible tent pole in that it can be assembled and disassembled by joining or disjoining its segments. Referring back to FIG. 2, the stiffening poles 6 are shown in a joined state, but are not yet inserted into the pole cover 1.

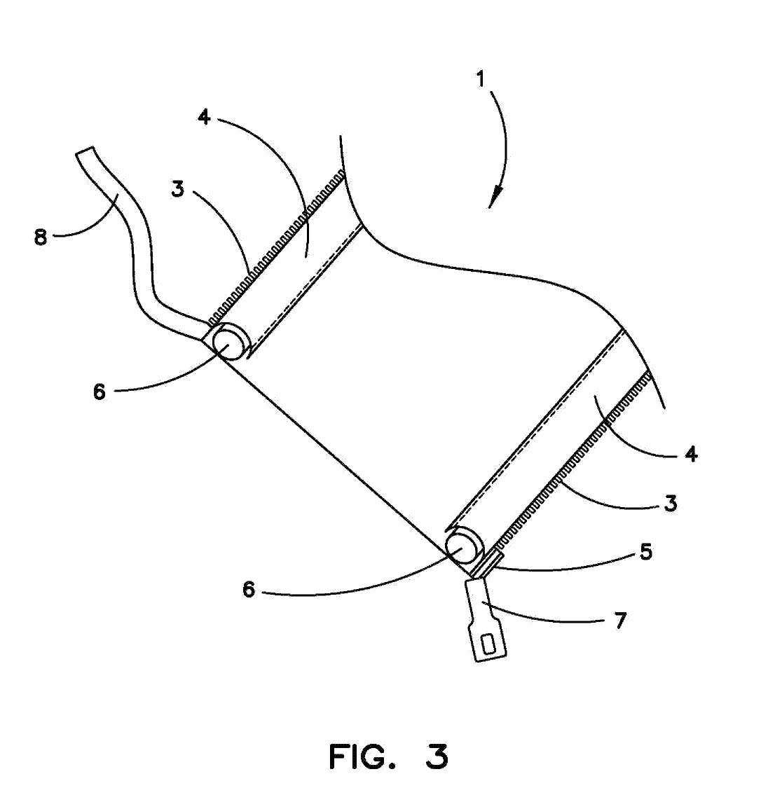

FIG. 3 is a magnified view of the lower portion of FIG. 1. The pockets 4 are now shown in greater detail. The stiffening members 6 have now been inserted into the pockets 4 by first assembling the stiffening members 6, and then by sliding the stiffening members into the pockets 4. It can be appreciated that although not mandatory, the stiffening members 6 and the pockets 4 are sized to cooperatively travel substantially the entire distance as the length of the zipper halves 3. The pockets 4 are sized to accept in a slidable fashion the stiffening members 6.

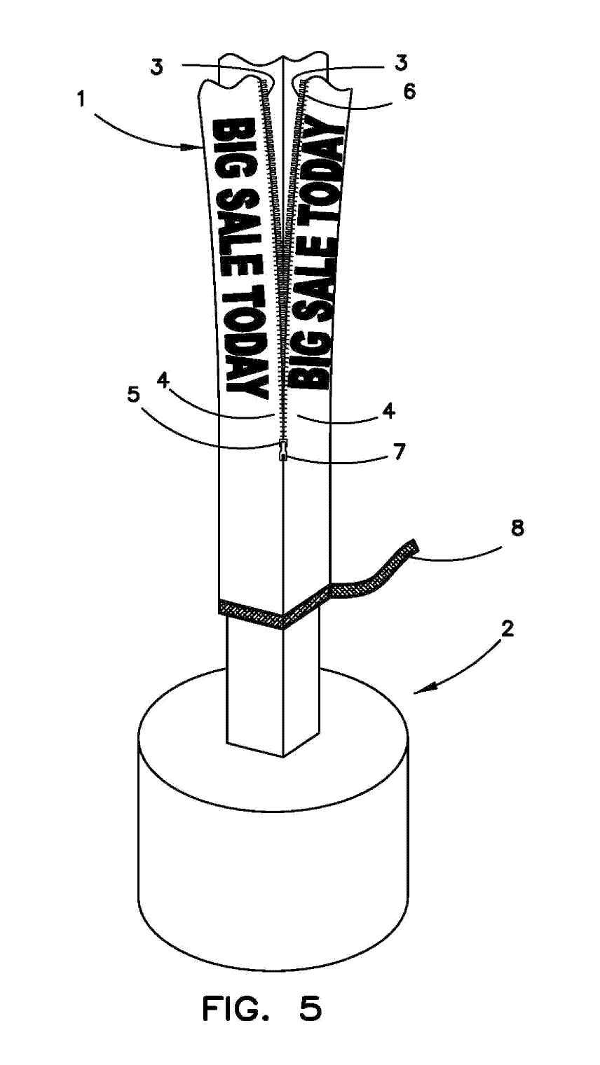

FIG. 5 shows a pole cover 1 that has been wrapped around a pole 2 ready for installation. The zipper halves 3 have been joined by inserting the zipper half 3 that does not contain the zipper slider 5, into the zipper slider 5. Typically upon installation the lower portion of the pole cover 1 is reachable by a human from the ground. The zipper slider pull tab 7 is grasped and slid in an upward direction thereby starting the engagement of the corresponding teeth of the zipper halves 3. Due to the stiffening members 6 being inserted into the pole cover 1, it has enough rigidity to hold itself up in a substantially vertical position in relation to the ground. This keeps the pole cover from falling down or otherwise misaligning the zipper halves 3 thereby making the task of fastening the zipper extremely difficult.

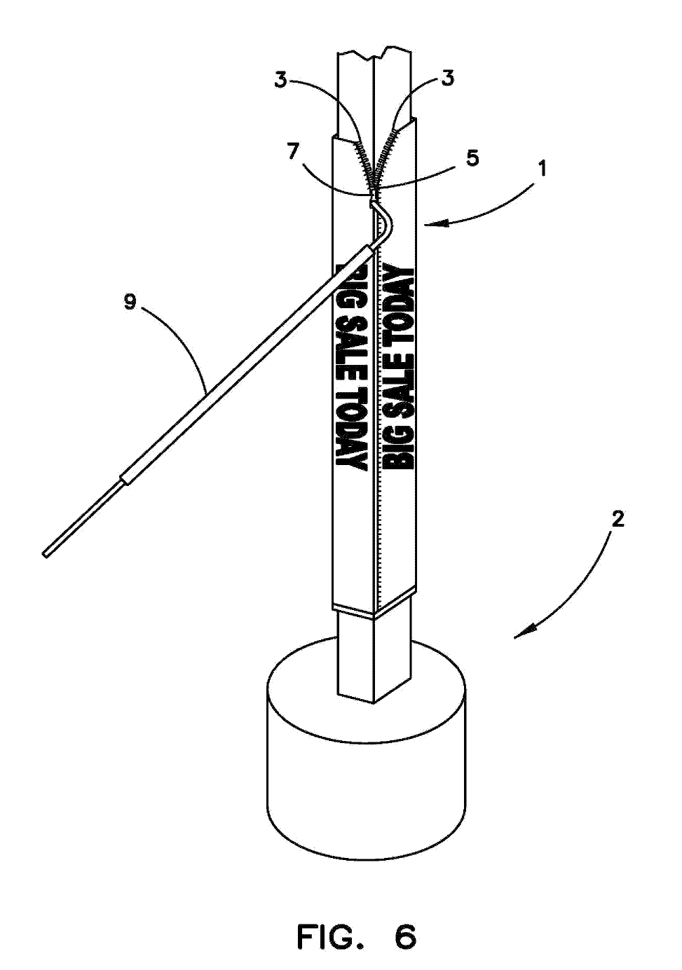

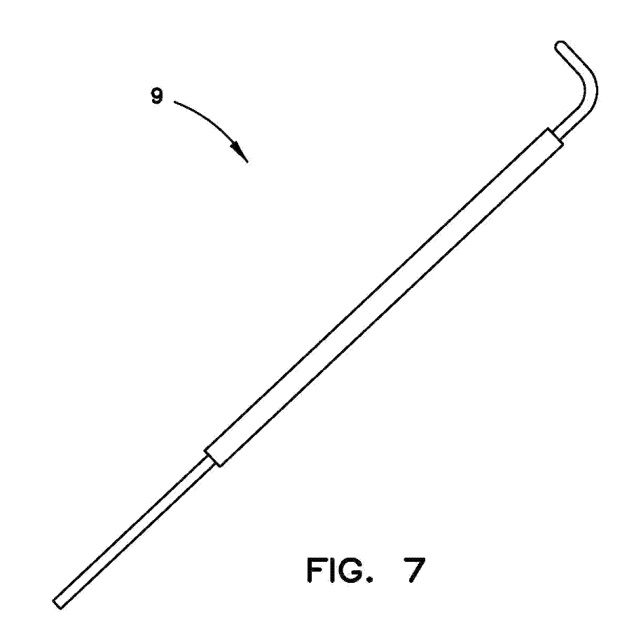

As the zipper slider 5 is slid in an upward direction, thusly fastening the zipper halves 5, there will likely come a point where the installer is no longer able to slide the zipper slider 5 any higher due to stature or height limitations of the installer. This occurs primarily when the top of the pole cover 1 to be installed will rests at a height that is taller than the installer's reach. Upon such an occurrence, the installer utilizes an elongated hooked tool 9 to complete the installation, see FIGS. 6 and 7. Referring specifically to FIG. 6, the hooked portion of the elongated hooked tool 9 is inserted into an aperture within the zipper slider pull tab 7. The hooked tool 9 is utilized to slide the zipper slider 5 in an upward fashion along the zipper halve 3 until it reaches the top of the zipper halves 3.

At this time the elongated hooked tool 9 is disengaged from the zipper slider pull tab 7. Referring again to FIG. 1, upon installation you can see that the zipper slider 5 is now located at the top of the pole cover 1 and is out of reach from the ground without the elongated hooked tool 9. You can appreciate that the pole cover 1 is secure from being removed without authorization since removing it would require the elongated hooked tool 9.

Upon completing the fastening of the zipper halves 3, the pole cover 1 is now installed upon the pole 2. In order to keep the pole cover 1 from sliding downward on the pole 2 or otherwise moving about on the pole 2, the tension strap 8 shown in FIGS. 1, 2, 3, 5, and 6 is installed by wrapping the tension strap 8 around the pole 2 and securing itself upon itself or to the edge of the pole cover 1 from which it originates. The tension strap 8 is wrapped in a snug manner wherein enough tension is provided between the tension strap 8 and the pole 2 that prohibits movement of the pole cover 1 in relation to the pole 2. A typical tension strap 8 is fastened by using Velcro. Of course it can be appreciated that any other suitable means to secure the tension strap 8 may also be employed, such as but not limited to, a snap, buckle, ties, or a zipper.

Due to the aerodynamic properties of the pole cover 1, weather conditions such as wind do not have a deteriorating effect upon its physical structure.

Since the pole cover 1 is installed upon a pole 2 without adhesives or other intrusive fasteners, there is no detrimental physical effect upon the pole which receives the pole cover 1. Upon the eventual removal of the pole cover 1, the pole cover 2 will not have to be peeled from the pole 2, nor will there be any messy adhesives to clean from the pole 2, which can be a time consuming process that can potentially damage the pole 2. Installation of the present invention is quick and easy and can usually be performed by one person without any specialized lifting equipment. Also, since the pole cover is not destroyed during the de-installation process, the pole cover can be used repeatedly. Also, the stiffening members 6 can typically be reused in subsequent pole cover 1 installations, which makes the design of my invention cost efficient.

Although in the above preferred embodiment a zipper was utilized to join the edges of the pole cover 1 around the pole, it can be appreciated that any suitable fastening device could be used in its place.

While the invention has been illustrated and described in detail in the drawings and foregoing description, the same is to be considered as illustrative and not restrictive in character, it being understood that only a preferred embodiment has been shown and described and that all changes and modifications that come within the spirit of the invention are desired to be protected.

I claim:

1. A cover comprising:
a flexible planar member sized to install upon a receiving member by wrapping said flexible planar member around said receiving member,
said flexible planar member having cooperative first and second edges which are joined by at least one connector upon installation of said flexible planar member upon said receiving member,
said flexible planar member is further defined as containing a support means to provide rigidity to the flexible planar member which eases installation of said flexible planar member upon said receiving member.

2. A cover as set forth in claim 1, wherein the connector is further defined as a zipper utilized to join said first and second edges.

3. A cover as set forth in claim 1, wherein the connector is further defined as a hook and loop fastening strips positioned along in close proximity to said first and second edges, a plurality of cooperative ties positioned along and in close proximity to said first and second edges, or a plurality or cooperatively positioned snaps positioned along and in close proximity to said first and second edges.

4. A cover as set forth in claim 1, wherein the support means is further defined by the flexible panel member having a least one integral cavity sized to receive at least one stiffening member.

5. A cover as set forth in claim 4, wherein the stiffening member is further defined as a collapsible segmented rod.

6. A cover comprising:
a flexible planar member sized to install upon a receiving member by wrapping said flexible planar member around said receiving member,
said flexible planar member having cooperative first and second edges which are joined by at least one connector upon installation of said flexible planar member upon said receiving member,
said flexible planar member is further defined as containing a support means to provide rigidity to the flexible planar member which eases installation of said flexible planar member upon said receiving member,
said flexible planar member further includes a securing member utilized to prevent movement of the flexible planar member upon the receiving member when said flexible planar member is installed upon said receiving member.

7. A cover as set forth in claim 6, wherein the connector is further defined as a zipper utilized to join said first and second edges.

8. A cover as set forth in claim 6, wherein the connector is further defined as a hook and loop fastening strips positioned along in close proximity to said first and second edges, a plurality of cooperative ties positioned along and in close proximity to said first and second edges, or a plurality or cooperatively positioned snaps positioned along and in close proximity to said first and second edges.

9. A cover as set forth in claim 6, wherein the support means is further defined by the flexible panel member having a least one integral cavity sized to receive at least one stiffening member.

10. A cover as set forth in claim 9, wherein the stiffening member is further defined as a collapsible segmented rod.

11. A cover as set forth in claim 6, wherein the securing member is further defined as a flexible strap having a first end and a second end.

12. A cover as set forth in claim 11, wherein the first end of the flexible strap is attached in close proximity to the first edge, and said second end is wrapped around said receiving member and secured to the second edge.

13. A method for attaching a cover to a receiving member comprising the steps of:
(a) inserting at least one stiffening member into a flexible panel member which is defined as having a first edge, a second edge, an upper edge, and a lower edge;
(b) wrapping the flexible panel member around a receiving member; and
(c) joining the first edge and second edge with a connector.

14. The method of claim 13, further including the step of joining the connector which is further defined as a zipper having a first half and a second half, a slider, and a zipper pull tab, after initiating engagement between the first half and the second half, an elongated hooked tool is engaged within said zipper pull tab and moved in an upward fashion thereby joining the connector as the slider is moved towards the upper edge.
